(19) United States
(12) Patent Application Publication
(10) Pub. No.: US 2009/0068516 A1
(43) Pub. Date: Mar. 12, 2009

(54) Fuel Cell System

(75) Inventor: Hiroyuki Kawai, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: TOYOTA JIDOSHA KABUSHIKI KAISHA, Toyota-shi (JP)

(21) Appl. No.: 12/087,314

(22) PCT Filed: Feb. 2, 2007
(86) PCT No.: PCT/IB2007/000265

§ 371 Date: Jul. 1, 2008

(30) Foreign Application Priority Data
Feb. 3, 2006 (JP) 2006-027029

(51) Int. Cl. H01M 8/04; H01M 8/24

(52) U.S. Cl. 429/24; 429/26

(57) ABSTRACT

A fuel cell system has a fuel cell stack (12) including a plurality of fuel cells that are stacked together, a heat transfer layer (14) that covers the fuel cell stack (12) and is formed at its periphery with recesses, and a low heat transfer layer (16) disposed in each of the recesses and having a low thermal conductivity. The low heat transfer layer (16) is fixed to a casing (18) such that the low heat transfer layer (16) closely contacts with the heat transfer layer (14) when the fuel cell stack (12) reaches its normal operating temperature, and such that the low heat transfer layer (16) is spaced apart from the heat transfer layer (14) due to thermal contraction during a process in which the temperature of the fuel cell stack (12) decreases from the normal operating temperature to the ambient temperature.

### BACKGROUND OF THE INVENTION

1. Field of the Invention

The invention relates to a fuel cell system, and particularly to a fuel cell system suitable for installation and use on a motor vehicle.

2. Description of the Related Art

A fuel cell system having a thermal insulating component that covers a fuel cell stack is known, as disclosed in, for example, JP-A-2004-87344. In the case where the fuel cell system is used to provide a cogeneration power-generating system, it is advantageous in terms of efficiency to utilize heat produced by the fuel cells during generation of electric power as energy. In this case, therefore, it is important to reduce loss of the heat produced by the fuel cells as much as possible.

In the system of the related art as identified above, the fuel cell stack is covered with the thermal insulating component so that the amount of heat dissipated from the fuel cell stack into the atmosphere is reduced, whereby heat loss of the system as a whole can be reduced. With this arrangement, the system is able to provide a power-generating system that operates with a high degree of efficiency. As another example of the related art, JP-A-2004-146337 discloses fuel cells that are operable in a middle-temperature range.

The above-described arrangement in which the fuel cell stack is covered with the thermal insulating component has the following advantage, other than providing a highly efficient power-generating system. Specifically, the use of the thermal insulating component makes it possible to keep the fuel cell stack at a sufficiently high temperature after the fuel cells stop operating. In general, the fuel cells deliver adequate power-generating performance when they reach an appropriate operating temperature. Accordingly, if the temperature of the fuel cells can be kept at a sufficiently high level after they stop operating, the fuel cells are able to deliver adequate power-generating performance in a short time upon a re-start thereof. In this regard, the fuel cell system as disclosed in JP-A-2004-87344 has an advantage of assuring a high degree of efficiency with which the fuel cells operate upon a re-start thereof.

However, in fuel cell systems installed on vehicles, for example, it may be desired or necessary to reduce the temperature of the fuel cells in a short time after a stop of the system. More specifically, in the case where the vehicle is expected to be stopped for a long period of time, for example, it is desirable to reduce the temperature of the fuel cells at an early time, in order to suppress or retard age-related degradation of the fuel cells and the surrounding elements. It is also convenient or advantageous if the fuel cells can be rapidly cooled, for example, in a situation in which maintenance is performed on the fuel cells.

The system as disclosed in JP-A-2004-87344 is configured to keep the temperature of the fuel cell stack at a sufficiently high temperature, by preventing heat from being dissipated from the fuel cell stack. Thus, the known system is not able to fulfill the above-described request or need, namely, the need for rapid cooling of the fuel cells.

### SUMMARY OF THE INVENTION

The invention provides a fuel cell system that can switch as needed between a condition suitable for a situation in which the fuel cells are to be efficiently kept at a high temperature, and a condition suitable for a situation in which the fuel cells are to be efficiently cooled.

According to a first aspect of the invention, there is provided a fuel cell system characterized by comprising: a fuel cell stack including a plurality of fuel cells that are stacked together, a first heat transfer layer that covers side faces of the fuel cell stack, and a second heat transfer layer disposed outside the first heat transfer layer, the second heat transfer layer having a lower thermal conductivity than the first heat transfer layer. In the fuel cell system, the second heat transfer layer closely contacts with the first heat transfer layer when the fuel cell stack reaches a normal operating temperature, and clearance is formed between the second heat transfer layer and the first heat transfer layer during a process in which the temperature of the fuel cell stack decreases from the normal operating temperature to an ambient temperature.

In a first embodiment of the first aspect of the invention, the fuel cell system may further comprise a casing in which the fuel cell stack, the first heat transfer layer and the second heat transfer layer are housed, and the second heat transfer layer may be fixed to the casing so as to closely contact with the first heat transfer layer when the fuel cell stack reaches the normal operating temperature.

In a second embodiment of the first aspect of the invention, the first heat transfer layer may have a plurality of recesses formed around the periphery thereof, and the second heat transfer layer may be disposed in each of the recesses such that the second heat transfer layer closely contacts with inner walls of each of the recesses when the fuel cell stack reaches the normal operating temperature.

In a third embodiment of the first aspect of the invention, the first heat transfer layer and the second heat transfer layer may have different thermal expansion characteristics.

In the third embodiment as described above, the first heat transfer layer may have a smaller coefficient of thermal expansion than the second heat transfer layer.

According to a second aspect of the invention, there is provided a fuel cell system comprising: (a) a fuel cell stack including a plurality of fuel cells that are stacked together, (b) a heat transfer layer that covers side faces of the fuel cell stack and forms at least one vent passage at the outside thereof, (c) a vent controller capable of controlling flow of a medium in the above-indicated at least one vent passage, (d) a thermal insulating layer that is disposed outside the heat transfer layer and the above-indicated at least one vent passage so as to cover the heat transfer layer and the vent passage(s), the thermal insulating layer having a lower thermal conductivity than the heat transfer layer, (e) two end-face covers that cover the opposite end faces of the fuel cell stack, and (f) at least one vent hole formed in each of the two end-face covers such that the vent hole(s) is/are respectively aligned with the corresponding vent passage(s) at the opposite end faces of the fuel cell stack.

In one embodiment of the second aspect of the invention, the vent controller may comprise a vent-passage blocking layer disposed in each of the above-indicated at least one vent passage.

In the above embodiment of the second aspect of the invention, the fuel cell system may further include a casing that includes the two end-face covers, and accommodates the fuel cell stack, the heat transfer layer, the vent-passage blocking layer and the thermal insulating layer, and the vent-passage blocking layer may be fixed to the casing so as to closely contact with the heat transfer layer when the fuel cell stack reaches the normal operating temperature.

In the above embodiment of the second aspect of the invention, the heat transfer layer may have a plurality of recesses formed around the periphery thereof, and the vent-passage blocking layer may be disposed in each of the recesses so as to closely contact with inner walls of each of the recesses when the fuel cell stack reaches the normal operating temperature.

In the above embodiment of the second aspect of the invention, the heat transfer layer and the vent-passage blocking layer may have different thermal expansion characteristics.

In the case as described just above, the heat transfer layer may have a smaller coefficient of thermal expansion than the vent-passage blocking layer.

In a second embodiment of the second aspect of the invention, the vent controller may include a control valve that opens and closes each of the above-indicated at least one vent hole, a rapid-cooling condition determining unit that determines whether a condition for rapid cooling of the fuel cell system is satisfied, and a rapid-cooling control unit that opens the control valve when the rapid-cooling condition is satisfied.

According to a third aspect of the invention, there is provided a fuel cell system comprising a fuel cell stack including a plurality of fuel cells that are stacked together, and a heat transfer layer that covers side faces of the fuel cell stack, and which is characterized in that a surface area of the heat transfer layer which is exposed to an outside atmosphere during normal operation of the fuel cell stack is different from that of the heat transfer layer during a stop of the fuel cell stack.

According to the first aspect of the invention, the side faces of the fuel cell stack are covered with the first heat transfer layer. During normal operation in which the fuel cell stack reaches its normal operating temperature, the second heat transfer layer is in close contact with the outer surface of the first heat transfer layer. In this case, heat dissipation from the fuel cell stack can be suppressed, and heat loss of the fuel cells can be reduced. When the fuel cells stop operating and the temperature of the fuel cells is reduced, clearance appears between the first heat transfer layer and the second heat transfer layer due to an influence of thermal contraction. As a result, heat dissipation from the fuel cell stack is promoted, and the fuel cells are rapidly cooled.

According to the first embodiment of the first aspect of the invention, the second heat transfer layer is fixed to the casing, which makes it possible to surely create a condition in which the second heat transfer layer is in close contact with the first heat transfer layer at the normal operating temperature, and a condition in which the second heat transfer layer is not in contact with or is spaced apart from the first heat transfer layer at reduced temperatures.

According to the second embodiment of the first aspect of the invention, the recesses are formed around the first heat transfer layer, and the second heat transfer layer is fitted in each of the recesses of the first heat transfer layer. With this arrangement, the surface area of the first heat transfer layer can be increased, and the areas of mutually opposed portions of the first and second heat transfer layers can be increased. Thus, this embodiment is able to provide a high degree of thermal insulation in a condition where the second heat transfer layer is in close contact with the first heat transfer layer, while providing a high degree of heat dissipation in a condition where the second heat transfer layer is spaced apart from the first heat transfer layer.

According to the third embodiment of the first aspect of the invention, one of the first and second heat transfer layers has a higher thermal expansion characteristic than the other layer. The above-indicated one heat transfer layer having the higher thermal expansion characteristic undergoes rapid thermal contraction as the temperature of the fuel cell stack decreases. Thus, the system of this embodiment is able to quickly switch from a condition in which it is preferred to keep the temperature of the fuel cells high, to a condition in which it is preferred to cool the fuel cells, without excessively restricting the freedom concerning the materials of the first heat transfer layer and the second heat transfer layer.

In the case where the first heat transfer layer has small coefficients of thermal expansion and contraction, the force acting between the first heat transfer layer and the fuel cell stack is prevented from varying by large degrees. In this case, the system is able to quickly switch from the “insulation-preferred condition” to the “cooling-preferred condition” while controlling the force applied to the side faces of the fuel cell stack to be within an adequate range.

According to the second aspect of the invention, the vent controller establishes a condition in which the vent passage(s) is/are blocked or closed at the normal operating temperature. In this case, no cooling medium flows over the periphery of the heat transfer layer, and, therefore, the fuel cell stack is not cooled so much, thus assuring a high degree of thermal insulation for the fuel cells. In other words, the fuel cells can be kept at a sufficiently high temperature. If the temperature of the fuel cells decreases, the vent controller forms a vent passage or passages around the heat transfer layer. The vent passages thus formed communicate with the vent holes of the opposite end-face covers. As a result, a cooling medium (e.g., air) is allowed to pass through the vent holes and vent passages and flow over the periphery of the fuel cell stack, so as to establish a condition in which cooling of the fuel cells is promoted.

According to the first embodiment of the second aspect of the invention, a condition in which the vent-passage blocking layer is in close contact with the heat transfer layer is established at the normal operating temperature. In this condition, no vent passage exists around the heat transfer layer, and, therefore, the fuel cell stack is not cooled so much even in the presence of the vent holes in the end-face covers, thus assuring a high degree of thermal insulation for the fuel cells. Namely, the fuel cells can be kept at a sufficiently high temperature. If the temperature of the fuel cells decreases, the vent-passage blocking layer is spaced apart from the heat transfer layer, and a vent passage is formed between the blocking layer and the heat transfer layer. The vent passages thus formed communicate with the corresponding vent holes of the end-face covers. As a result, a cooling medium (e.g., air) is allowed to flow over the periphery of the fuel cell stack, so as to establish a condition in which cooling of the fuel cells is promoted.

In the case where the vent-passage blocking layer is fixed to the casing (a part of which provides the above-mentioned end-face covers) in the embodiment as described just above, the fuel cell system is able to surely create a condition in which the vent-passage blocking layer is in close contact with the heat transfer layer at the normal operating temperature, and a condition in which the vent-passage blocking layer is not in contact with or is spaced apart from the heat transfer layer at reduced temperatures.

In the embodiment as described above, where the recesses are formed around the heat transfer layer, and the vent-passage blocking layer is fitted in each of the recesses of the heat transfer layer, the surface area of the heat transfer layer can be increased, and the areas of mutually opposed portions of the vent-passage blocking layers and heat transfer layer can be increased. The system thus constructed is able to provide a high degree of thermal insulation in a condition where the vent-passage blocking layer is in close contact with the heat transfer layer, while providing a high degree of heat dissipation in a condition where the vent-passage blocking layer is spaced apart from the heat transfer layer.

In the case where one of the heat transfer layer and the vent-passage blocking layer has a higher thermal expansion characteristic than the other layer in the embodiment as described above, the one layer having the higher thermal expansion characteristic undergoes rapid thermal contraction as the temperature of the fuel cell stack decreases. In this case, therefore, the system is able to quickly switch from a condition in which it is preferred to keep the temperature of the fuel cells high, to a condition in which it is preferred to cool the fuel cells, without excessively restricting the freedom concerning the materials of the heat transfer layer and the vent-passage blocking layer.

In the case where the heat transfer layer has small coefficients of thermal expansion and contraction, the force acting between the heat transfer layer and the fuel cell stack is prevented from varying by large degrees. In this case, therefore, the system is able to quickly switch from the “insulation-preferred condition” to the “cooling-preferred condition” while controlling the force applied to the side faces of the fuel cell stack to be within an adequate range.

According to the second embodiment of the second aspect of the invention, the vent holes formed in the end-face covers can be opened only when the rapid-cooling condition is satisfied. Namely, according to this embodiment, the vent passage or passages can be formed around the heat transfer layer only when the rapid-cooling condition is satisfied. Thus, the system of this embodiment is able to create a condition in which cooling of the fuel cells is preferred while the fuel cells are stopped, only in the case where the fuel cells are actually required to be rapidly cooled.

According to the third aspect of the invention, the side faces of the fuel cell stack are covered with the heat transfer layer, and the surface area of the heat transfer layer which is exposed to an outside atmosphere during normal operation of the fuel cell stack is different from that of the heat transfer layer during a stop of the fuel cell stack. In this case, heat dissipation from the fuel cell stack during normal operation can be suppressed, and heat loss of the fuel cells can be reduced. While the fuel cells stop operating, the surface area of the heat transfer layer which is exposed to the outside atmosphere is increased, so that heat dissipation from the fuel cell stack is promoted, and the fuel cells are rapidly cooled.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a perspective, cross-sectional view useful for explaining the construction of a fuel cell system according to a first embodiment of the invention;

FIG. 2 is a view useful for explaining the structure of a low heat transfer layer shown in FIG. 1;

FIG. 3 is a view useful for explaining a condition of the fuel cell system of the first embodiment under low-temperature circumstances;

FIG. 4 is a perspective, cross-sectional view useful for explaining the construction of a fuel cell system according to a second embodiment of the invention;

FIG. 5 is a view showing an end portion of the fuel cell system as shown in FIG. 4;

FIG. 6 is a view useful for explaining a condition of the fuel cell system of the second embodiment under low-temperature circumstances;

FIG. 7 is a perspective, cross-sectional view showing an end portion of a fuel cell system constructed according to a third embodiment of the invention; and

FIG. 8 is a flowchart of a routine executed in the third embodiment of the invention.

### DETAILED DESCRIPTION OF THE EMBODIMENTS

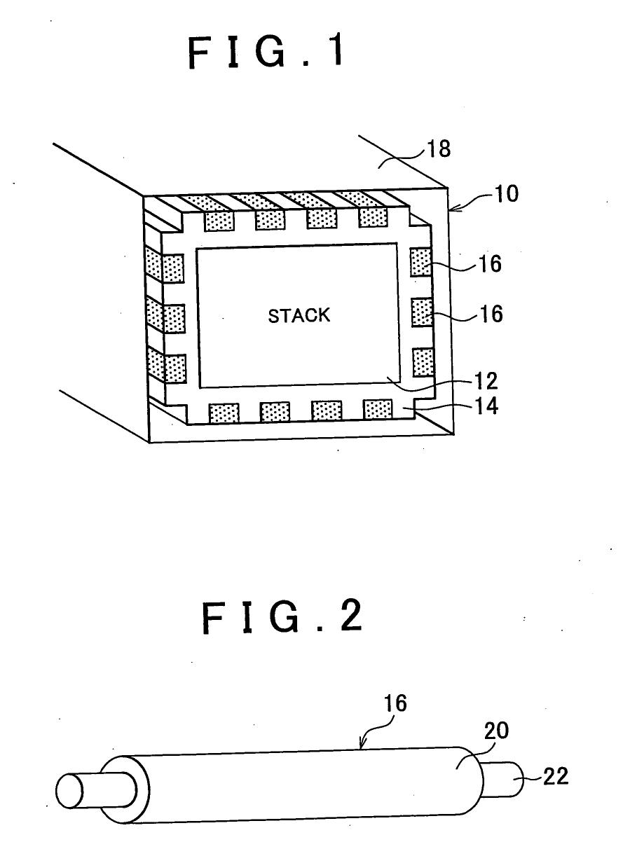

Referring to FIG. 1 through FIG. 3, the first embodiment of the invention will be described. FIG. 1 is a perspective, cross-sectional view useful for explaining the construction of a fuel cell system 10 as the first embodiment of the invention. The fuel cell system 10 is installed on a motor vehicle for use thereon, and includes a fuel cell stack 12. The fuel cell stack 12 consists of a plurality of fuel cells that are stacked together. FIG. 1 shows a cross section of the fuel cell system 10, which is obtained by cutting the system along a surface of one of the fuel cells.

A heat transfer layer 14 (which may be regarded as “first heat transfer layer” according to the invention) is provided at the outside of the fuel cell stack 12 so as to cover all of the four side faces of the fuel cell stack 12. The heat transfer layer 14 is formed of a material having a high thermal conductivity and a small coefficient of thermal expansion. In this embodiment, the heat transfer layer 14 is formed of nickel.

The heat transfer layer 14 has recesses or grooves formed around the periphery thereof. A low heat transfer layer 16 (which may be regarded as “second heat transfer layer” according to the invention) is disposed in each of the recesses of the heat transfer layer 14. The low heat transfer layer 16 is formed of a material having a low thermal conductivity. In this embodiment, the low heat transfer layer 16 is formed of antimony.

The fuel cell stack 12, heat transfer layer 14 and the low heat transfer layers 16 are housed in a casing 18. In this embodiment, the heat transfer layer 14 and the low heat transfer layers 16 are exposed to the interior space of the casing 18.

FIG. 2 is a view useful for explaining the structure of the low heat transfer layer 16. The low heat transfer layer 16 consists of a thermal expansion portion 20 and a fixed portion 22. Although the thermal expansion portion 20 takes the shape of a cylinder in FIG. 2, for the sake of explanation, the thermal expansion portion 20 of this embodiment is actually formed in the shape of a rectangular column, so that the thermal expansion portion 20 can be fitted in each of the recesses of the heat transfer layer 14.

The fixed portion 22 of the low heat transfer layer 16 has a smaller diameter than the thermal expansion portion 20, and projects from the opposite ends of the thermal expansion portion 20. Also, the fixed portion 22 and the thermal expansion portion 20 are formed around their center axes as a common axis, namely, are formed coaxially with each other. The low heat transfer layer 16 is positioned such that the thermal expansion portion 20 is located in the corresponding recess of the heat transfer layer 14, and such that the fixed portion 22 projects from the longitudinally opposite ends of the heat transfer layer 14. The fixed portion 22 is fixed to the casing 18 so as to determine the position of the low heat transfer layer 16.

The fuel cell stack 12 generates electric power while producing heat. During operation, therefore, the fuel cell stack 12 reaches a sufficiently high temperature as compared with room temperature (ambient temperature). This temperature will be hereinafter called “normal operating temperature”. In this embodiment, the fuel cell stack 12 consists of hydrogen membrane fuel cells (HMFC), and, therefore, its normal operating temperature is in the range of 100 to 600° C.

While the temperature of the fuel cell stack 12 is varying between room temperature and the normal operating temperature, thermal deformations appear in the heat transfer layer 14 and the low heat transfer layers 16, respectively. FIG. 1 shows a condition of the fuel cell system 10 under circumstances where the fuel cell stack 12 reaches the normal operating temperature (100-600° C.), namely, under circumstances where the heat transfer layer 14 and the low heat transfer layers 16 are thermally expanded to sufficient extents. As shown in FIG. 1, the fuel cell system 10 of this embodiment is constructed such that the low heat transfer layers 16 closely contact with the inner walls of the recesses of the heat transfer layer 14 when the fuel cell stack 12 reaches the normal operating temperature.

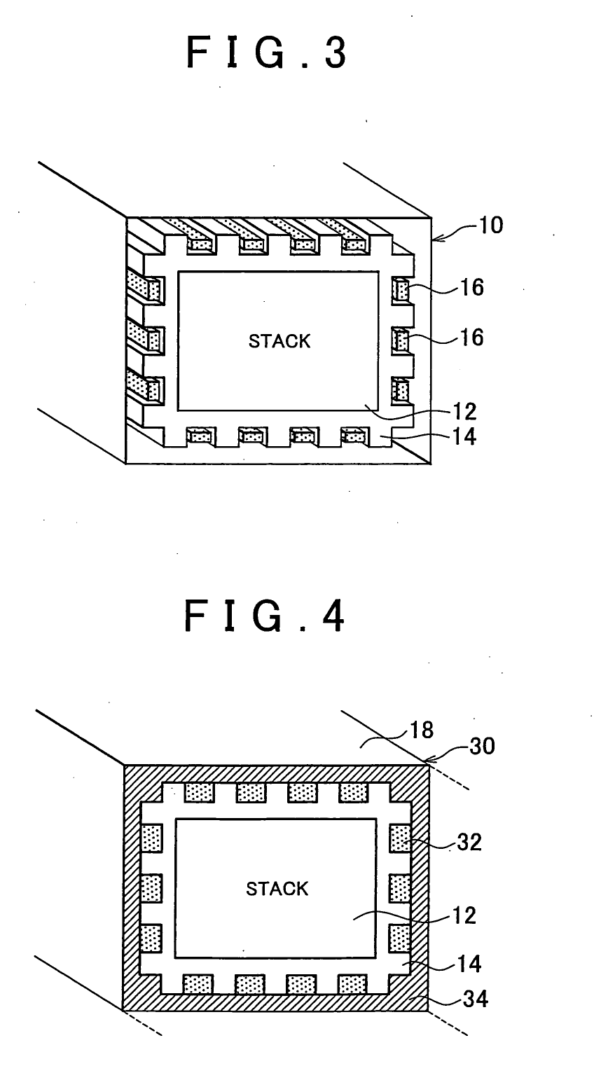

FIG. 3 is a view useful for explaining a condition of the fuel cell system 10 under circumferences where the temperature of the fuel cell stack 12 has been sufficiently reduced as compared with the normal operating temperature. As the temperature of the fuel cell stack 12 decreases, the temperatures of the heat transfer layer 14 and low heat transfer layers 16 decrease, and these layers 14, 16 undergo thermal contraction. Since the low heat transfer layers 16 are fixed to the casing 18 as described above, the low heat transfer layers 16 are suspended in the recesses of the heat transfer layer 14 due to thermal contraction of these layers 14, 16, and clearances are formed between the heat transfer layer 14 and the low heat transfer layers 16.

In the condition as shown in FIG. 1, namely, in the condition in which the low heat transfer layers 16 are fitted in the recesses of the heat transfer layer 14, some portions of the surface of the heat transfer layer 14 (i.e., the inner walls of the recesses) are covered with the low heat transfer layers 16. The low heat transfer layers 16 prevent heat from being transferred or conducted and from being dissipated. Thus, in the case as shown in FIG. 1, heat produced by the fuel cell stack 12 is dissipated mainly from portions of the surface of the heat transfer layer 14 which are not covered with the low heat transfer layers 16.

In the condition as shown in FIG. 3, namely, in the condition in which the low heat transfer layers 16 are spaced apart from the recesses of the heat transfer layer 14, on the other hand, the entire surface of the heat transfer layer 14 is exposed to the interior of the casing 18. In this case, heat produced by the fuel cell stack 12 is dissipated from the entire surface of the heat transfer layer 14.

For the above reasons, the condition as shown in FIG. 1 is more suitable for thermal insulation for keeping the fuel cell stack 12 at a sufficiently high temperature than the condition as shown in FIG. 3. Thus, the condition of FIG. 1 will be hereinafter called “insulation-preferred condition” in which a higher priority is given to thermal insulation for the fuel cell stack 12. On the other hand, the condition as shown in FIG. 3 is more suitable for cooling of the fuel cell stack 12 than the condition as shown in FIG. 1. Thus, the condition of FIG. 3 will be hereinafter called “cooling-preferred condition” in which a higher priority is given to cooling of the fuel cell stack 12.

The fuel cell system 10 of this embodiment delivers adequate power-generating performance when the fuel cell stack 12 reaches the normal operating temperature of 100 to 600° C. During power generation, the fuel cell stack 12 produces heat so as to increase its temperature to the normal operating temperature. An efficient method for keeping the fuel cell stack 12 at the normal operating temperature is to prevent heat from being dissipated from the fuel cell stack 12 in an attempt to achieve thermal insulation thereof. It is thus desirable to establish the above-mentioned “insulation-preferred condition” during operation of the fuel cell system 10.

In the case where the fuel cell system 10 is kept stopped, on the other hand, it is not necessary to hold the fuel cell stack 12 at a high temperature. Also, various constituent members or components of the system 10 are more likely to degrade as the members are placed under higher-temperature circumstances. Accordingly, it is desirable to reduce the temperature of the fuel cell stack 12 immediately after a stop of the system 10 in order to suppress degradation of the fuel cell system 10.

Furthermore, in the case where maintenance, such as upkeep, checkup or repair, is performed on the fuel cell system 10, the temperature of the fuel cell stack 12 needs to be sufficiently reduced. It is thus desirable to rapidly reduce the temperature of the fuel cell stack 12 after the system 10 is stopped, in order to provide good maintainability of the fuel cell system 10. To meet this need, it is effective to establish the above-mentioned “cooling-preferred condition” after the fuel cell system 10 is stopped.

In the fuel cell system 10, it may be advantageous to maintain the “insulation-preferred condition” even while the fuel cell system 10 is stopped, so as to rapidly raise the temperature of the fuel cell stack 12 to the normal operating temperature upon a re-start of the system 10. However, since the hydrogen membrane fuel cells (HMFC) used in this embodiment have a sufficient ability to generate heat, the temperature of the fuel cell stack 12 can be raised to the normal operating temperature in a sufficiently short time even if the fuel cell stack 12 has a significantly reduced temperature at the time when the system 10 is re-started. Thus, in the fuel cell system 10 of this embodiment, in particular, it is advantageous or preferable to establish the “cooling-preferred condition” when the system 10 is stopped.

As described above, the fuel cell system 10 of this embodiment is able to establish the condition (i.e., the “insulation-preferred condition”) as shown in FIG. 1, under circumstances of the normal operating temperature. On the other hand, the fuel cell system 10 is able to establish the condition (i.e., the “cooling-preferred condition”) as shown in FIG. 3 as the temperature of the fuel cell stack 12 decreases after the system 10 stops operating. Thus, the fuel cell system 10 of this embodiment is able to appropriately satisfy both of the need for thermal insulation during operation and the need for rapid cooling after a stop thereof.

While the heat transfer layer 14 is formed of nickel in the first embodiment as described above, the invention is not limited to the use of this particular material. More specifically, the heat transfer layer 14 may be formed of a material, such as tungsten or molybdenum, which has a high thermal conductivity and a small coefficient of thermal expansion. In addition, the heat transfer layer 14 may be formed of aluminum, or the like, having a large coefficient of thermal expansion unless excessively large stress is applied to the fuel cell stack 12 due to thermal contraction of the heat transfer layer 14. These modifications may be applied to other embodiments as described below.

While the low heat transfer layer 16 is formed of antimony in the first embodiment as described above, the invention is not limited to the use of this particular material. While antimony is thermally stable and has a low coefficient of thermal expansion, the low heat transfer layer 16 may be formed of a material, such as a resin complex, which has a low thermal conductivity and a large thermal expansion coefficient. In this case, the low heat transfer layers 16 undergo large thermal contraction as the temperature of the fuel cell stack 12 decreases, which makes it easier to form large clearances between the heat transfer layer 14 and the low heat transfer layers 16. The fuel cell system thus constructed provides excellent cooling capability when rapid cooling of the fuel cells is required.

While the heat transfer layer 14 is formed with the recesses, and the low heat transfer layers 16 are disposed in the respective recesses in the first embodiment as described above, members disposed in the recesses may be formed of a material that does not have a low thermal conductivity. More specifically, the low heat transfer layers 16 may be replaced by aluminum members having a high thermal conductivity and a large thermal expansion coefficient, and the aluminum members may be disposed in the recesses of the heat transfer layer 14.

In the case where the aluminum members are disposed in the recesses of the heat transfer layer 14, the aluminum members are fitted in the recesses of the heat transfer layer 14 at the normal operating temperature, and the aluminum members and the heat transfer layer 14 cooperate to provide an integral structure having no recesses formed in the outer surface thereof. In this case, the surface area of the structure provides a heat dissipation area over which heat is dissipated from the fuel cell stack 12. If the aluminum members undergo thermal contraction and are spaced apart from the recesses of the heat transfer layer 14, on the other hand, the surface area of the heat transfer layer 14 provides the heat dissipation area for the fuel cell stack 12.

The heat transfer layer 14, which has the recesses formed at the periphery thereof, has a larger surface area than the above-mentioned structure. Accordingly, where the aluminum members are disposed in the recesses in place of the low heat transfer layers 16, the heat dissipation area for the fuel cell stack 12 is relatively small at the normal operating temperature, and increases as the temperature decreases. With this arrangement, it is possible to create the insulation-preferred condition during operation of the fuel cell system 10, and create the cooling-preferred condition during stops of the fuel cell system 10, in the same manners as in the system of the first embodiment.

While the fuel cell stack 12 is limited to the hydrogen membrane fuel cells (HMFC) in the first embodiment as described above, the invention is not limited to the use of HMFC. Rather, the fuel cell stack 12 may consist of other types of fuel cells. This modification is also applied to other embodiments as described below.

While the heat transfer layer 14 is formed at its periphery with the recesses and the low heat transfer layers 16 are disposed in the recesses in the first embodiment as described above, the invention is not limited to this arrangement. Rather, the heat transfer layer 14 may have a flat outer surface, and the low heat transfer layer 16 may be arranged to cover the flat surface.

Referring next to FIG. 4 through FIG. 6, the second embodiment of the invention will be explained. FIG. 4 is a perspective, cross-sectional view useful for explaining the construction of a fuel cell system 30 as the second embodiment of the invention. In FIG. 4, the same reference numerals are used for identifying the same constituent elements as those of FIG. 1, and explanation of these elements is simplified or not provided.

The fuel cell system 30 of this embodiment is provided with vent-passage blocking layers 32 (which may be regarded as “vent controller” according to the invention), in place of the low heat transfer layers 16 employed in the first embodiment. Like the low heat transfer layers 16, the vent-passage blocking layers 32 are disposed in the recesses of the heat transfer layer 14. The vent-passage blocking layers 32 are formed of a material that has a large coefficient of thermal expansion and may have a high or low thermal conductivity. In this embodiment, the vent-passage blocking layers 32 are formed of, for example, aluminum or brass.

Like the low heat transfer layer 16 of the first embodiment, the vent-passage blocking layer 32 has a thermal expansion portion to be received in each of the recesses of the heat transfer layer 14, and a fixed portion that projects from the opposite ends of the thermal expansion portion, as shown in FIG. 2. The fixed portion of the vent-passage blocking layer 32 is fixed to the casing 18. The vent-passage blocking layers 32 are arranged to closely contact with the inner walls of the recesses of the heat transfer layer 14 when the fuel cell stack 12 reaches the normal operating temperature.

A thermal insulating layer 34 is provided between the heat transfer layer 14 and vent-passage blocking layers 32, and the casing 18. The thermal insulating layer 34 is formed of a material, such as antimony, which has a lower thermal conductivity than the heat transfer layer 14. More specifically, the thermal insulating layer 34 is arranged to closely contact with all of the heat transfer layer 14, vent-passage blocking layers 32 and the inner walls of the casing 18 under circumstances as shown in FIG. 4, namely, under a situation in which the fuel cell stack 12 reaches its normal operating temperature.

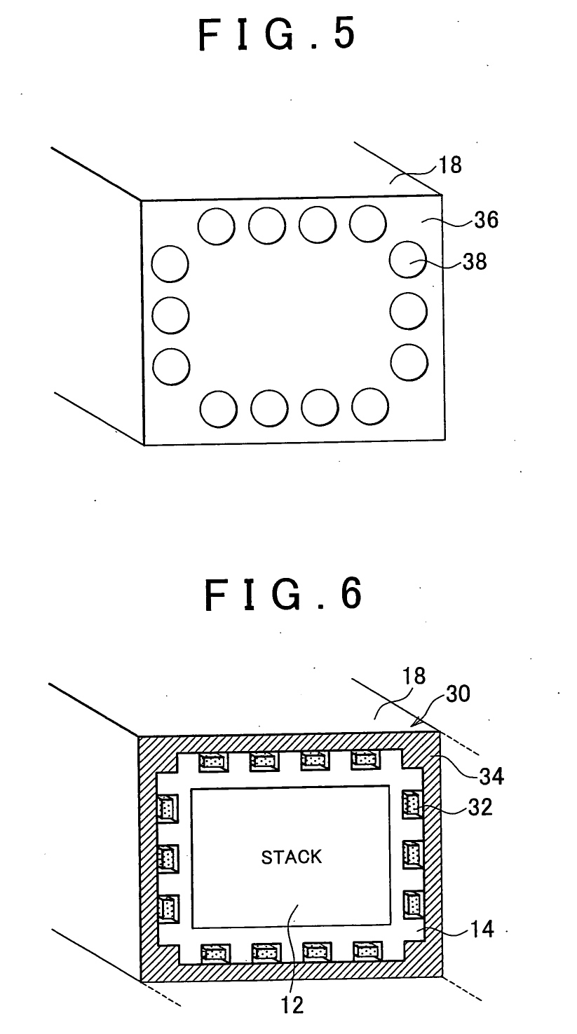

FIG. 5 is a perspective view showing one end face of the casing 18. The casing 18 has an end-face covers 36 at each of the opposite end faces thereof, as shown in FIG. 5. The end-face cover 36 has a plurality of vent holes 38 formed at its locations aligned with the end faces of the vent-passage blocking layers 32. Accordingly, the end faces of the vent-passage blocking layers 32 are exposed, via the vent holes 38, to the atmosphere present outside the casing 18.

FIG. 6 is a view useful for explaining a condition of the fuel cell system 30 under a situation in which the temperature of the fuel cell stack 12 has been reduced to a level sufficiently lower than the normal operating temperature. As the temperature of the fuel cell stack 12 decreases, the temperatures of the heat transfer layer 14, vent-passage blocking layers 32 and the thermal insulating layer 34 decrease, and these layers 14, 32, 34 undergo thermal contraction. At this time, particularly large thermal contraction appears in the vent-passage blocking layers 32 having a large thermal expansion coefficient. Upon occurrence of thermal contraction, the vent-passage blocking layers 32, which are fixed to the casing 18, are brought into a condition in which the layers 32 are spaced apart from both of the heat transfer layer 14 and the thermal insulating layer 34. As a result, vent passages that extend in the longitudinal direction of the fuel cell stack 12 are formed around the vent-passage blocking layers 32, as shown in FIG. 6.

In the condition as shown in FIG. 4, namely, in the condition where the vent-passage blocking layers 32 are in close contact with the recesses of the heat transfer layer 14 and the thermal insulating layer 32, no vent passage exists around the fuel cell stack 12. In this case, no cooling medium (e.g., air) flows around the fuel cell stack 12 even if the vent holes 38 are open at the opposite ends of the vent-passage blocking layers 32. In this case, therefore, a condition suitable for keeping the fuel cell stack 12 at a high temperature, or “insulation-preferred condition”, is established.

If the vent passages are formed around the vent-passage blocking layers 32 as shown in FIG. 6, on the other hand, the vent holes 38 provided at the opposite ends of the casing 18 communicate with each other via the vent passages. This condition allows a cooling medium (e.g., air) to flow around the fuel cell stack 12. Thus, the condition as shown in FIG. 6 provides a condition suitable for cooling of the fuel cell stack 12, or “cooling-preferred condition”.

As explained above, the fuel cell system 30 of this embodiment is able to establish the “insulation-preferred condition” under circumstances of the normal operating temperature, and establish the “cooling-preferred condition” when the system 30 is stopped and the temperature of the fuel cell stack 12 is reduced, as in the case of the first embodiment. Thus, like the system of the first embodiment, the system 30 of this embodiment is able to appropriately satisfy both of the need for thermal insulation during operation and the need for rapid cooling after the system 30 is stopped.

While the vent-passage blocking layers 32 are formed of aluminum or brass in the second embodiment as described above, the invention is not limited to the use of these materials. Rather, the vent-passage blocking layers 32 may be formed of any material provided that they can form vent passages between the recesses of the heat transfer layer 14 and the thermal insulating layer 34. For example, the vent-passage blocking layers 32 may be formed of a material, such as antimony, which has a small coefficient of thermal expansion and a low thermal conductivity, or a material, such as nickel, tungsten or molybdenum, which has a small coefficient of thermal expansion and a high thermal conductivity, or a material, such as a resin complex, which has a large coefficient of thermal expansion and a low thermal conductivity. It is, however, desirable to form the vent-passage blocking layers 32 of a material having a large thermal expansion coefficient, since the use of such a material makes it easier to form large vent passages.

While the thermal insulating layer 34 is formed of antimony in the second embodiment as described above, the invention is not limited to the use of this material. Rather, the thermal insulating layer 34 may be formed of any material having a low thermal conductivity. For example, the thermal insulating layer 34 may consist of a resin complex, or the like.

While the recesses are formed in the outer surface of the heat transfer layer 14, and the vent-passage blocking layers 32 are disposed in the recesses in the second embodiment as described above, the invention is not limited to this arrangement. Rather, the heat transfer layer 14 may have a flat outer surface, and the vent-passage blocking layer 32 may be arranged to cover the flat surface.

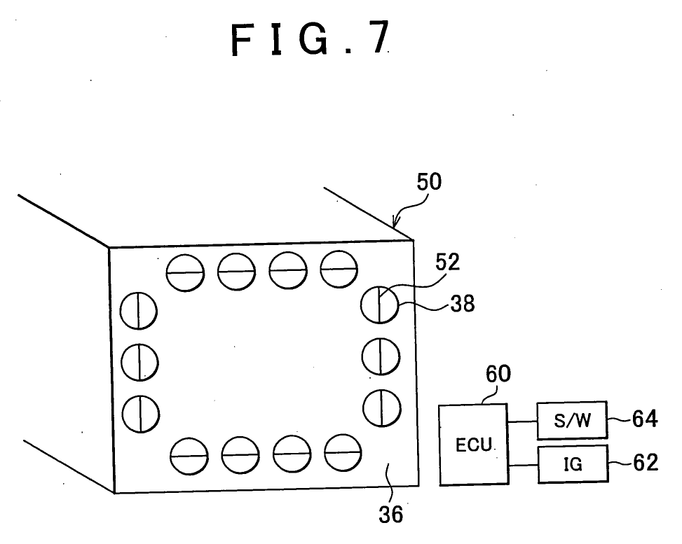

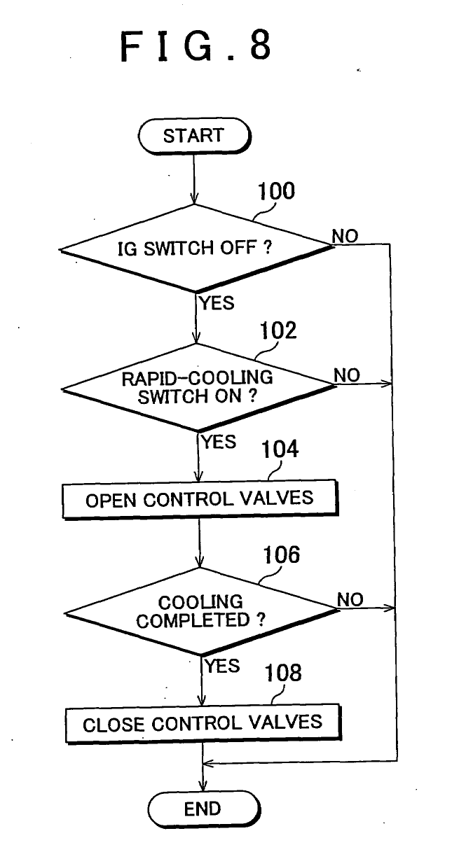

Referring next to FIG. 7 and FIG. 8, the third embodiment of the invention will be described. FIG. 7 is a perspective, cross-sectional view useful for explaining the construction of a fuel cell system 50 as the third embodiment of the invention. In FIG. 7, the same reference numerals are used for identifying the same constituent elements as those explained above with respect to the second embodiment, and explanation of these elements will be simplified or not provided.

As shown in FIG. 7, the system of this embodiment includes control valves 52 for closing the respective vent holes 38 formed in the end-face covers 36. Each of the control valves 52 is arranged to pivot about its center axis, thereby to open or close the corresponding vent hole 38.

The system of this embodiment further includes an ECU (Electronic Control Unit) 60. To the ECU 60 are connected an ignition switch (IG) 62 of the vehicle and a rapid-cooling request switch (S/W) 64. The ECU 60 is able to open and close the control valves 52 as needed, in response to the outputs of these switches. The ECU 60, ignition switch 62, rapid-cooling request switch 64 and control valves 52 may be regarded as “vent controller” according to the invention.

FIG. 8 is a flowchart of a routine executed by the ECU 60. In the routine shown in FIG. 8, it is initially determined whether the IG switch 62 of the vehicle is in the OFF position (step 100). If the IG switch 62 is not in the OFF position, it can be judged that the fuel cell system 50 is in operation, and the “insulation-preferred condition” should be established. In this case, there is no need to open the control valves 52, and, therefore, the current processing cycle is immediately finished.

If it is judged in step 100 that the IG switch 62 is OFF, it can be judged that the fuel cell system 50 is stopped. In this case, it is then determined whether the rapid-cooling request switch 64 is in the ON position (step 102).

The rapid-cooling request switch 64 may be manually operated to the ON position in the case where the fuel cell system 50 is expected to be stopped for a long period of time or the case where maintenance is needed. Thus, when the rapid-cooling request switch 64 is not in the ON position, it can be judged that rapid cooling of the fuel cell system 50 is not requested. In this situation, it is desirable to maintain the “insulation-preferred condition” even after the fuel cell system 50 is stopped, so as to ensure good re-starting capability. Thus, when it is determined that the rapid-cooling request switch 64 is not in the ON position, the current processing cycle is finished without opening the control valves 52.

In the system 50 of this embodiment, when the control valves 52 are closed, a cooling medium (e.g., air) does not flow through the vent passages even if the passages are formed around the vent-passage blocking layers 16. Accordingly, the “insulation-preferred condition”, namely, a condition suitable for keeping the fuel cell stack 12 at a sufficiently high temperature, is maintained irrespective of the presence or absence of the vent passages. Thus, according to the arrangement of this embodiment, the “insulation-preferred condition” can be maintained even after the fuel cell system 50 is stopped, in a situation in which the system 50 need not be rapidly cooled.

If it is determined in step 102 that the rapid-cooling request switch 64 is ON in the routine shown in FIG. 8, it can be judged that rapid cooling of the fuel cell system 50 is requested. In this case, the control valves 52 are then placed in the open state (step 104). If the control valves 52 are opened, the vent holes 38 are opened, and a condition similar to that provided in the second embodiment is established. With the vent holes 38 being open, the “cooling-preferred condition” is established as the temperature of the fuel cell stack 12 decreases. Thus, in a situation in which rapid cooling of the fuel cell system 50 is requested, the system of this embodiment is able to fulfill this request with high reliability.

Subsequently, the ECU 60 determines whether cooling of the fuel cell system 50 is completed (step 106). Here, it is determined, for example, whether the temperature of the fuel cell stack 12 has been reduced to a level lower than a predetermined judgment value, or whether the time for which the control valves 52 are opened has reached a predetermined judgment time. If an affirmative decision (YES) is obtained in step 106, it is judged that cooling is completed.

If it is determined in step 106 that cooling has not been completed (i.e., a negative decision (NO) is obtained in step 106), the current processing cycle is finished while the control valves 52 are left open. If an affirmative decision (YES) is obtained in step 106, the control valves 52 are brought into the closed state (step 108).

According to the routine shown in FIG. 8 as explained above, the fuel cell system 50 is always held in the “insulation-preferred condition” during operation, and is placed in the “cooling-preferred condition” only in the case where rapid cooling is requested while the system 50 is stopped. Thus, the system of this embodiment is able to appropriately fulfill all of the need for thermal insulation during operation of the system 50, an improvement in the re-starting capability, and the request for rapid cooling where it is actually necessary.

While a request for rapid cooling of the fuel cell system 50 is sent to the ECU 60 through a manual operation in the third embodiment as described above, the invention is not limited to this method. Rather, the ECU 60 may automatically determine the presence or absence of a request for rapid cooling, depending upon whether specified conditions are satisfied or not.

In the third embodiment as described above, a portion of the ECU 60 which executes steps 100 and 102 provides “rapid-cooling condition determining unit” according to the invention, and a portion of the ECU 60 which executes step 104 provides “rapid-cooling control unit” according to the invention.

Furthermore, in the third embodiment as described above, cooling fans may be disposed adjacent to the vent holes 38, and their operations may be controlled so as to forcedly feed a cooling medium (air) into the vent passages in response to a command from the ECU 60 when rapid cooling is requested and the control valves 52 are opened.

Thus, the embodiments of the invention that have been disclosed in the specification are to be considered in all respects as illustrative and not restrictive. The technical scope of the invention is defined by claims, and all changes which come within the meaning and range of equivalency of the claims are therefore intended to be embraced therein.

1. A fuel cell system, comprising:
a fuel cell stack including a plurality of fuel cells that are stacked together;
a first heat transfer layer that covers side faces of the fuel cell stack; and
a second heat transfer layer disposed outside the first heat transfer layer, the second heat transfer layer having a lower thermal conductivity than the first heat transfer layer, wherein
the second heat transfer layer closely contacts with the first heat transfer layer when the fuel cell stack reaches a normal operating temperature, and clearance is formed between the second heat transfer layer and the first heat transfer layer during a process in which the temperature of the fuel cell stack decreases from the normal operating temperature to an ambient temperature.

2. A fuel cell system according to claim 1, wherein the fuel cell system further comprises a casing in which the fuel cell stack, the first heat transfer layer and the second heat transfer layer are housed, and wherein
the second heat transfer layer is fixed to the casing so as to closely contact with the first heat transfer layer when the fuel cell stack reaches the normal operating temperature.

3. A fuel cell system according to claim 2, wherein the first heat transfer layer and the second heat transfer layer are exposed to an interior space of the casing.

4. A fuel cell system according to claim 1, wherein the first heat transfer layer has a plurality of recesses formed around the periphery thereof, and wherein
the second heat transfer layer is disposed in each of the recesses such that the second heat transfer layer closely contacts with inner walls of each of the recesses when the fuel cell stack reaches the normal operating temperature.

5. A fuel cell system according to claim 1, wherein the first heat transfer layer and the second heat transfer layer have different thermal expansion characteristics.

6. A fuel cell system according to claim 5, wherein the first heat transfer layer has a smaller coefficient of thermal expansion than the second heat transfer layer.

7. A fuel cell system according to claim 1, wherein the fuel cell stack comprises hydrogen membrane fuel cells.

8. A fuel cell system according to claim 7, wherein the normal operating temperature of the hydrogen membrane fuel cells is in a range of 100 to 600° C.

9. A fuel cell system, comprising:
a fuel cell stack including a plurality of fuel cells that are stacked together;
a heat transfer layer that covers side faces of the fuel cell stack and forms at least one vent passage at the outside thereof;
a vent controller capable of controlling flow of a medium in said at least one vent passage;
a thermal insulating layer that is disposed outside the heat transfer layer and said at least one vent passage so as to cover the heat transfer layer and said at least one vent passage, the thermal insulating layer having a lower thermal conductivity than the heat transfer layer;
two end-face covers that cover the opposite end faces of the fuel cell stack; and
at least one vent hole formed in each of the two end-face covers such that said at least one vent hole is respectively aligned with said at least one vent passage at the opposite end faces of the fuel cell stack.

10. A fuel cell system according to claim 9, wherein the vent controller comprises a vent-passage blocking layer disposed in each of said at least one vent passage.

11. A fuel cell system according to claim 10, wherein the vent-passage blocking layer closely contacts with the heat transfer layer when the fuel cell stack reaches the normal operating temperature, and clearance is formed between the vent-passage blocking layer and the heat transfer layer during a process in which the temperature of the fuel cell stack decreases from the normal operating temperature to an ambient temperature.

12. A fuel cell system according to claim 10, wherein the fuel cell system further comprises a casing that includes the two end-face covers, and accommodates the fuel cell stack, the heat transfer layer, the vent-passage blocking layer and the thermal insulating layer, and wherein
the vent-passage blocking layer is fixed to the casing so as to closely contact with the heat transfer layer when the fuel cell stack reaches the normal operating temperature.

13. A fuel cell system according to claim 10, wherein the heat transfer layer has a plurality of recesses formed around the periphery thereof, and wherein
the vent-passage blocking layer is disposed in each of the recesses so as to closely contact with inner walls of each of the recesses when the fuel cell stack reaches the normal operating temperature.

14. A fuel cell system according to claim 10, wherein the heat transfer layer and the vent-passage blocking layer have different thermal expansion characteristics.

15. A fuel cell system according to claim 14, wherein the heat transfer layer has a smaller coefficient of thermal expansion than the vent-passage blocking layer.

16. A fuel cell system according to claim 9, wherein the vent controller comprises:
a control valve that opens and closes each of said at least one vent hole;
a rapid-cooling condition determining unit that determines whether a condition for rapid cooling of the fuel cell system is satisfied; and
a rapid-cooling control unit that opens the control valve when the rapid-cooling condition is satisfied.

17. A fuel cell system according to claim 9, wherein the fuel cell stack comprises hydrogen membrane fuel cells.

18. A fuel cell system according to claim 17, wherein the normal operating temperature of the hydrogen membrane fuel cells is in a range of 100 to 600° C.

19. A fuel cell system, comprising:
a fuel cell stack including a plurality of fuel cells that are stacked together; and
a heat transfer layer that covers side faces of the fuel cell stack, wherein
a surface area of the heat transfer layer which is exposed to an outside atmosphere during normal operation of the fuel cell stack is different from that of the heat transfer layer during a stop of the fuel cell stack.

20. A fuel cell system according to claim 19, wherein the heat transfer layer includes:
a first heat transfer layer having a plurality of recesses formed around the periphery thereof; and
a second heat transfer layer that is disposed outside the first heat transfer layer and is received in each of the recesses, wherein
the second heat transfer layer closely contacts with the first heat transfer layer when the fuel cell stack reaches a normal operating temperature, and clearance is formed between the second heat transfer layer and the first heat transfer layer during a process in which the temperature of the fuel cell stack decreases from the normal operating temperature to an ambient temperature.
